(19) United States
(12) Patent Application Publication
(10) Pub. No.: US 2018/0322158 A1
(43) Pub. Date: Nov. 8, 2018

(54) CHANGING CONCURRENCY CONTROL MODES

(71) Applicant: HEWLETT PACKARD ENTERPRISE DEVELOPMENT LP, Houston, TX (US)

(72) Inventors: Huanchen Zhang, Palo Alto, CA (US); Kimberly Keeton, Palo Alto, CA (US)

(21) Appl. No.: 15/585,153

(22) Filed: May 2, 2017

(51) Int. Cl. G06F 17/30

(52) U.S. Cl. CPC G06F 17/30362; G06F 17/30356; G06F 17/30353

(57) ABSTRACT

Example implementations relate to changing concurrency control modes. An example implementation includes controlling a concurrency control mode of a data slot that stores a data value. A concurrency control mode of a data slot may be changed from an optimistic concurrency control mode to a multi-version concurrency control mode responsive to detecting a read-write conflict for the data slot. A concurrency control mode of a data slot may be changed from a multi-version concurrency control mode to an optimistic concurrency control mode responsive to detecting that the data slot satisfies a low contention criterion.

### BACKGROUND

Concurrency control systems aim to provide database transaction isolation for data in a system accessed by multiple users. Where multiple users attempt to read and/or write to a data slot in a database in parallel, controls are implemented such that a first transaction does not adversely affect other transactions and that the serializability of the system is not violated. For example, pessimistic concurrency controls may be implemented to lock an entity in the database such that a holder of a lock may disallow anyone from reading or writing to the entity.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a block diagram illustrating a system for changing a concurrency control mode according to some examples.

FIG. 2 is a block diagram further illustrating a system for changing a concurrency control mode according to some examples.

FIG. 3 is a block diagram illustrating a non-transitory computer readable medium for changing a concurrency control mode according to some examples.

FIG. 4. is a flowchart illustrating a method for changing a concurrency control mode according to some examples.

FIG. 5 is a block diagram illustrating a transaction record buffer having an optimistic concurrency control buffer and a multi-version concurrency control buffer according to some examples.

FIG. 6 is a flowchart illustrating a method for executing a transaction according to some examples.

FIG. 7 is a flowchart illustrating a method for validating and committing a transaction according to some examples.

FIG. 8 is a flowchart illustrating a method for executing a read request according to some examples.

FIG. 9 is a flowchart illustrating a method for executing a write request according to some examples.

FIG. 10 is a flowchart illustrating a method for validating a read request according to some examples.

FIG. 11 is a flowchart illustrating a method for validating a write request according to some examples.

FIG. 12 is a flowchart illustrating a method for post-commit operations according to some examples.

### DETAILED DESCRIPTION

Systems, methods, and equivalents for adaptively changing the concurrency control mode of a data slot are provided. A concurrency control mode is defined by the operational procedures used to maintain the consistency of the database entity when facing concurrent transactions. Concurrency control modes aim to prevent the adverse effects of transactions attempting to modify data in a database concurrently. Specifically, concurrency control modes aim to maintain consistency of an entity in a database interacted with by multiple transactions in parallel by maintaining the principles of serializability within a data system. Serializability is maintained where a database state resulting from multiple concurrent transactions mimics the result of the transactions executing serially.

Multiple concurrency control modes may be implemented in a database. A pessimistic concurrency control (PCC) mode, for instance, may limit concurrency by allowing readers and writers to “lock” data, disallowing other readers and writers from submitting transactions, such as read or write transactions, with respect to the data. For example, data may be locked in the database and accessible only by the lock holder such that the lock holder has exclusive access to update the data.

Optimistic concurrency control (OCC) is a concurrency control mode that may enable multiple readers and writers to perform transactions on the same data or entity and abort a transaction before committing in the event the transaction would violate the principle of serializability within the system i.e. where there is a read-write conflict. In an example of OCC, a single version of data is maintained, the data is read in shared memory, and the data is written to in private memory. When in an OCC mode, transactions may be validated before they are committed, and a transaction may be aborted if the transaction is found to be invalid. For example, if a transaction attempts to write to data that was modified by another transaction subsequent to the time the data was read by the transaction, the transaction may be found to be invalid and aborted. In an example, the transaction may be retried responsive to the abort.

Multi-version concurrency control (MVCC) is a concurrency control mode that, unlike OCC, may not abort a transaction before committing in the event a read-write conflict would occur. In MVCC, an additional version of the data or entity may be created responsive to detecting a read-write conflict. MVCC may mimic isolation within the database by creating a snapshot of data at a point in time at which the transaction is initiated. The transaction may perform on the additional version, i.e. the snapshot, until such time as a commit occurs.

A timestamp may be applied to the additional version to mark the time of creation of the additional version. Where multiple additional versions are created, the additional versions may be ordered by timestamp. A timestamp may similarly be applied to a transaction, which may mark a time the transaction was initiated, mark a time the transaction last read from data, etc. In an example, a timestamp assigned to the transaction may be compared with the timestamps of any number of the ordered additional versions and may read or write to the additional version that has the latest timestamp prior to the timestamp of the transaction. In doing so, the transaction may maintain a consistent view of the database on which it is operating.

In the following description, for purposes of explanation, numerous specific details are set forth in order to provide a thorough understanding of the present systems and methods. For some examples, the present systems and methods may be practiced without these specific details. Reference in the specification to “an example” or similar language means that a particular feature, structure, or characteristic described in connection with that example is included as described, but may not be included in other examples. In other instances, methods and structures may not be described in detail to avoid unnecessarily obscuring the description of the examples. Also, the examples may be used in combination with each other.

The following terminology is understood to mean the following when recited by the specification or the claims. The singular forms “a,” “an,” and “the” mean “one or more.” The terms “including” and “having” are intended to have the same inclusive meaning as the term “comprising.”

Any of the processors discussed herein may include a microprocessor, a microcontroller, a programmable gate array, an application-specific integrated circuit (ASIC), a computer processor, or the like. Any of the processors may, for example, include multiple cores on a chip, multiple cores across multiple chips, multiple cores across multiple devices, or combinations thereof. In some examples, any of the processors may include at least one integrated circuit (IC), other control logic, other electronic circuits, or combinations thereof.

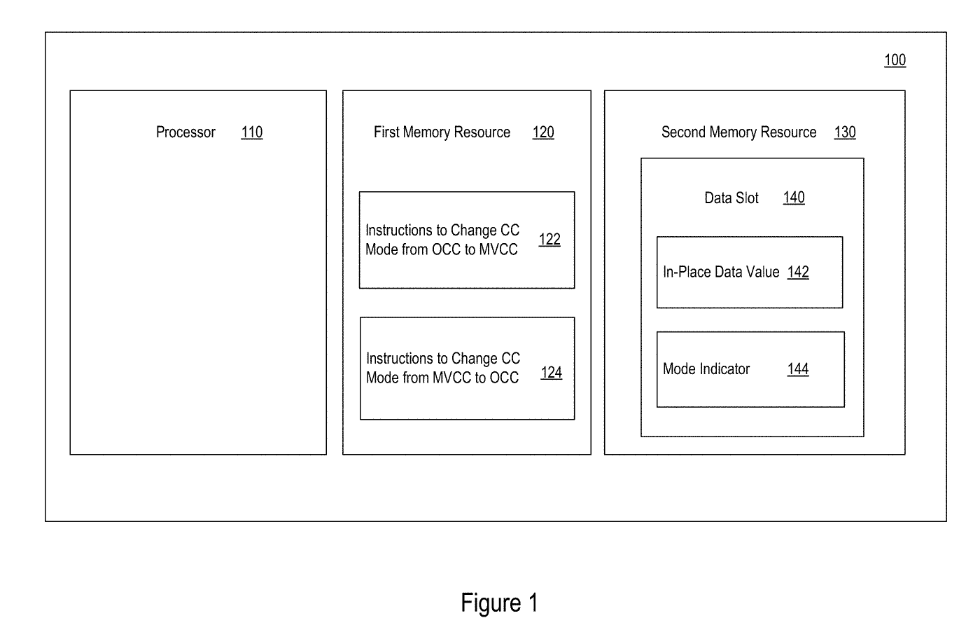

A concurrency control mode for a data slot may be changed. A data slot may include any number of data fields for housing data within a database. FIG. 1 is an example system 100 for dynamically changing the concurrency control mode of a data slot. System 100 may include a processor 110 and a set of memory resources, e.g. first memory resource 120 and second memory resource 130. A memory resource, as generally described herein, can include any number of volatile or non-volatile memory components capable of storing instructions that can be executed by a processor. It is appreciated that memory resources may be integrated into a single device or distributed across multiple devices. Further, memory resources may be fully or partially integrated into the same device (e.g., a server) as their corresponding processor or they may be separate from but accessible to their corresponding processor. The set of memory resources may store data in a database and/or executable instructions to be executed by a processor.

Second memory resource 130 may store data in a database. The database may include a data slot 140 having in-place data field 142 to house an in-place data value which may be a committed data value. In an example, the housed committed data value may be a latest committed data value of the data slot.

Data slot 140 may also include a mode indicator field 144. In an example, the mode indicator field 144 may house data, such as a mode indicator, to indicate what concurrency control mode the data slot is in. For instance, mode indicator field 144 may house a mode indicator to indicate whether the concurrency control mode of the data slot is in optimistic concurrency control (OCC) mode or multi-version concurrency control (MVCC) mode. Specifically, the mode indicator may indicate that the concurrency control mode of the data slot is in OCC mode, such that a transaction with respect to the data slot is aborted upon detection of a read-write conflict. The mode indicator may also indicate that the concurrency control mode of the data slot is in MVCC mode, such that an additional version of the committed data value may be created responsive to detecting the read-write conflict.

Instructions may be provided in first memory resource 120 of system 100. Specifically, instructions 122 may be provided to change a concurrency control (CC) mode from OCC to MVCC. In an example, instructions 122 may change the concurrency mode from OCC to MVCC responsive to detecting a read-write conflict for the data slot. Instructions 124 may also be provided in first memory resource 120 to change the CC mode from MVCC to OCC. In an example, instructions 124 may change the CC mode from MVCC to OCC responsive to detecting that the data slot satisfied a low contention criterion which is described in greater detail herein. Accordingly, instructions may be provided in first memory resource 120 to switch from OCC to MVCC and from MVCC to OCC.

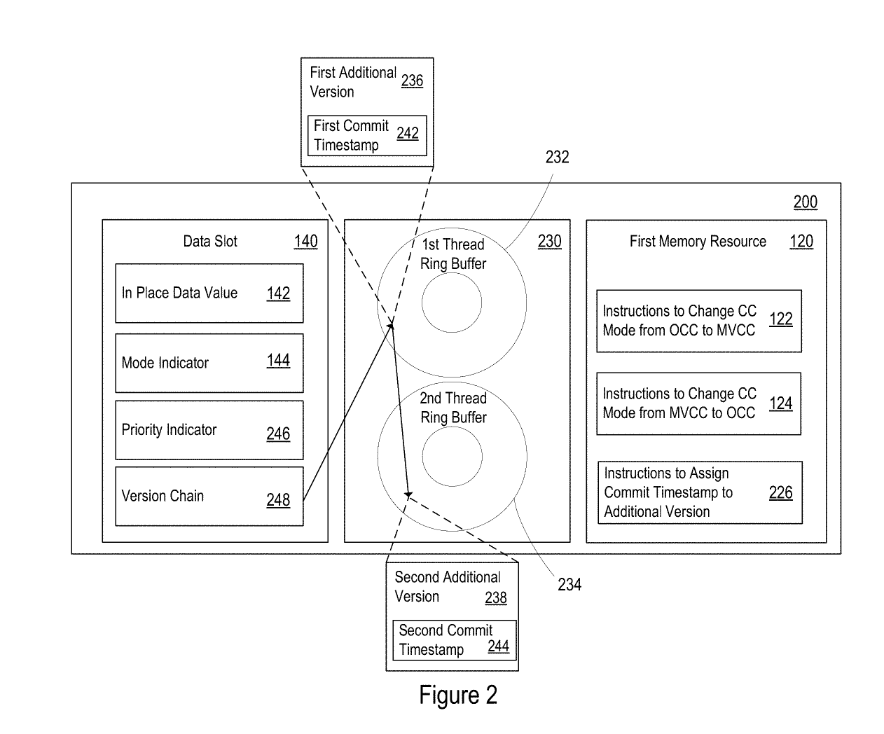

FIG. 2 is an additional example system 200 for dynamically changing the concurrency control mode of a data slot. System 200 may include similar architecture to that of system 100. For clarity and conciseness, many of the components of system 200 may be described with reference to FIG. 1, including data slot 140 and fields within data slot 140, such as in-place data field 142, and mode indicator field 144. Components of system 200 that may be described with reference to FIG. 1 may further include first memory resource 120, and instructions within first memory resource 120, including instructions 122 to change the concurrency control mode from OCC to MVCC, and instructions 124 to change the concurrency control mode from MVCC to OCC.

A transaction, or a succession of transactions, may be executed by a thread. A thread may be a unit of execution, i.e., the thread executes instructions that operate on data stored in memory. In an example, transactions executed by different threads will be stored in the ring buffer of the respective thread. An example memory in the form of a collection 230 of two per-thread ring buffers is illustrated in FIG. 2. In this example, one ring buffer is represented for each thread of execution. For instance, collection of ring buffers 230 may include first additional version 236 stored within first thread ring buffer 232 of collection 230, and second additional version 238 stored within second thread ring buffer 234 of collection 230. In this example, first additional version 236 stored within first ring buffer 232 may be executed by a first thread and second additional version 238 stored within second ring buffer 234 may be executed by a second thread. In an example, a transaction record stored within one of the collection of ring buffers 230 may contain multiple updates in the form of additional versions for various in-place data fields, such as in-place data field 142.

Additional fields may be included within data slot 140 in addition to in-place data field 142 and mode indicator 144, including priority indicator 246 and version chain locator 248. Version chain locator 248 may locate any transaction seeking to update in-place data field 142, and specifically, may locate any created additional versions in the form of updates to in-place data field 142. In an example, a created additional version to update in-place data field 142 may be stored within a transaction record located in memory. A transaction record may be stored within a cyclical ring-buffer. The cyclical ring-buffer may describe the logical organization of the data in memory. Any number of ring-buffers may be utilized, and may depend on any number of physical processors in the system, the load on the database server, etc.

In an example, multiple updates in the form of additional versions may be stored in any number of per-thread ring buffers within collection 230. Additional versions stored within different per-thread ring buffers, e.g., where created by different threads, may be linked in the form of a version chain. The version chain located by version chain locater 248 may link together multiple created additional versions for a single data slot. In an example, the created additional versions may be linked sequentially such that a first additional version of the created additional versions points to a second additional version of the created additional versions that was created earlier in time than was the first additional version. For instance, a first additional version stored within first thread ring buffer 232 may point to a second additional version stored within second thread ring buffer 234. While two per-thread ring buffers are illustrated in example system 200, additional versions may be stored and linked between any number of per-thread ring buffers. Thus, version chain locator 248 may locate the version chain stored within the collection of per-thread ring buffers 230.

Priority indicator 246 may also be provided within data slot 140 and may indicate from which data slot field a read should first occur. For example, priority indicator 246 may indicate whether a read should first occur from in-place data field 142 of data slot 140 or the additional versions pointed to by version chain locator 248.

A timestamp may be assigned to an additional version of a data value upon committing. Memory 120 may include instructions 226 to assign a commit timestamp to an additional version. Thus, each additional version stored within a per-thread ring buffer may be assigned a commit timestamp indicating the time at which the additional version committed. For example, first additional version 236 may be assigned first commit timestamp 242 and second additional version 238 may be assigned second commit timestamp 244. The assigned timestamps may keep record of when each additional version was committed to the version chain.

Any of the non-transitory computer-readable storage media described herein may include a single medium or multiple media. The non-transitory computer readable storage medium may comprise any electronic, magnetic, optical, or other physical storage device. For example, the non-transitory computer readable storage medium may include, for example, random access memory (RAM), static memory, read-only memory, an electrically erasable programmable read-only memory (EEPROM), a hard drive, an optical drive, a storage drive, a CD, a DVD, or the like.

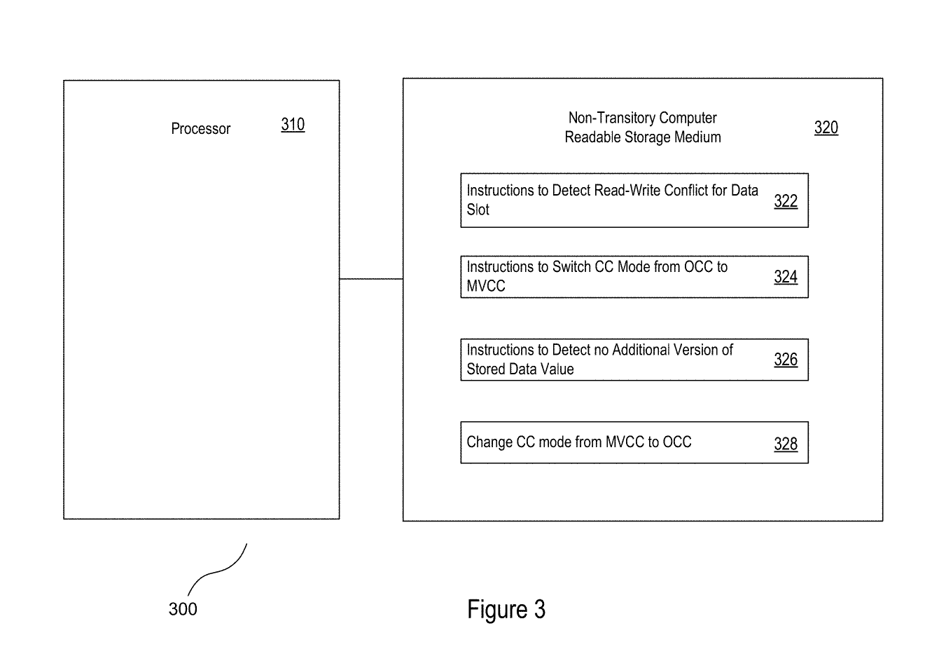

FIG. 3 illustrates a block diagram 300 of an example non-transitory computer-readable storage medium 320 for changing a concurrency control mode of a data slot. The non-transitory computer-readable storage medium 320 may include instructions 322 executable by a processor, e.g. processor 310, to detect a read-write conflict for a data slot. In an example, the read-write conflict may be detected by assigning a timestamp to a received transaction, e.g. indicating a time at which the transaction was received or a time at which the transaction was executed, and determining that the timestamp is earlier in time than a commit time of a stored data value in the data slot. Determining that the timestamp is earlier in time than a commit time of a stored data value in the data slot may indicate that a commit to the data slot occurred after the transaction was received or executed. A commit to the data slot subsequent to the execution of the transaction could, for example, violate the serializability of a system and create a read-write conflict. Thus, a timestamp assigned to a transaction may be compared to a commit time to a data slot in order to detect whether a read-write conflict could occur.

During moments of high contention at a data slot, a concurrency mode of the data slot may be switched from an optimistic concurrency control (OCC) mode to a multi-version concurrency control (MVCC) mode. Instructions 324 may be provided to change a concurrency control mode of the data slot from an OCC mode to an MVCC mode. In an example, the OCC mode aborts a transaction upon detecting a read-write conflict. When in an OCC mode, transactions may be validated before they are committed, and a transaction may be aborted where the transaction is found to be invalid. In an example, the MVCC mode creates a snapshot of the data targeted by the transaction in the form of an additional version of the stored data value upon detecting a read-write conflict such that concurrent transactions may read and/or write to identical values from a given point in time and an illusion of isolation within the system may be maintained.

During moments of low contention at the data slot, a low contention criterion may be satisfied such that the concurrency control mode of the data slot may be switched from MVCC mode to OCC mode. In an example, the satisfaction of the low contention criterion may be determined from a version chain field of a data slot, such as version chain locator 248 of FIG. 2.

Instructions 326 may detect that the version chain field is empty, indicating that there are no additional versions of the stored data value stored within the collection of per-thread ring buffers. Where the version chain is empty the low contention criterion may be satisfied. In an example, the low contention criterion may be satisfied where the version chain is made up of less than a threshold amount of additional versions.

The data slot may be changed from MVCC mode to OCC mode where the version chain of the data slot does not point to any additional version of the stored data value. Instructions 328 are provided to change the concurrency control mode from MVCC mode to OCC mode responsive to detecting that the version chain does not point to any additional version of the stored data value. Accordingly, a non-transitory computer readable medium may be provided to dynamically switch a data slot from OCC mode to MVCC mode during periods of high contention, and from MVCC mode to OCC mode during periods of low contention.

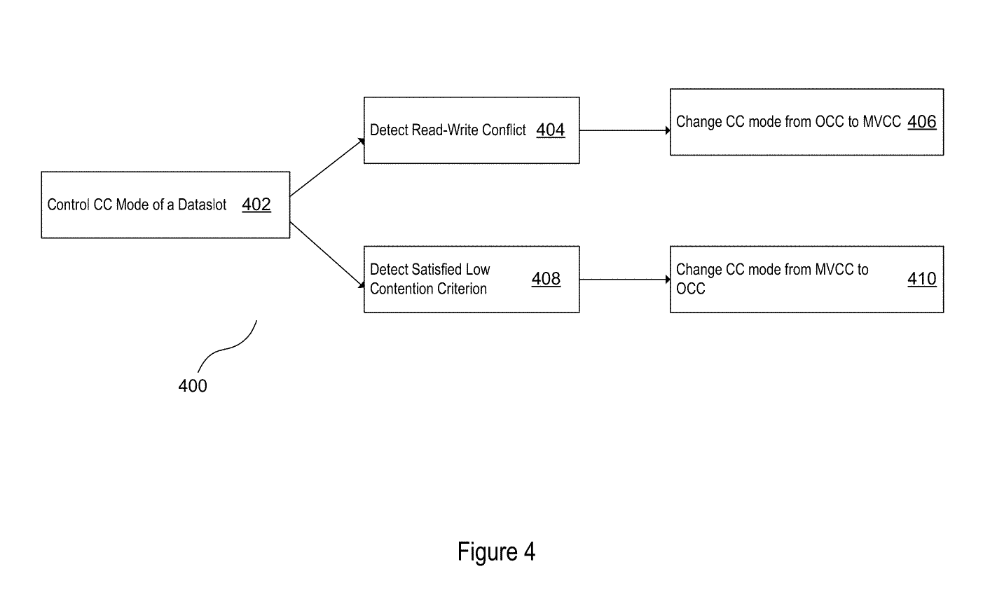

FIG. 4 is a flowchart illustrating an example method 400 for controlling a concurrency control mode of a data slot. Block 402 illustrates that a concurrency control (CC) mode of a data slot may be controlled, for example, by detecting a read-write conflict for the data slot at block 404 and/or by detecting that the data slot satisfied a low contention criterion at block 408. Specifically, at block 406 the concurrency control mode of the data slot may be changed from an optimistic concurrency control (OCC) mode to a multi-version concurrency control mode (MVCC) mode responsive to detecting a read-write conflict for the data slot at block 404. Additionally, the concurrency control mode of the data slot may be changed from MVCC mode to OCC mode at block 410 responsive to detecting a low contention criterion at block 408, e.g. where the version chain of the data slot makes up less than a threshold amount of additional versions. Accordingly, a method is provided for changing a concurrency control mode of a data slot from OCC to MVCC and from MVCC to OCC.

The method may be implemented in the form of executable instructions stored on a computer-readable medium or in the form of electronic circuitry. For example, method 400 may be implemented by executable instructions in a non-transitory computer readable medium as in example FIG. 3, or by instructions in memory as in example FIG. 1. The sequence of operations described in connection with FIG. 4 is not intended to be limiting, and an implementation consistent with the example of FIG. 4 may be performed in a different order than the example illustrated. Additionally, operations may be added or removed from method 400.

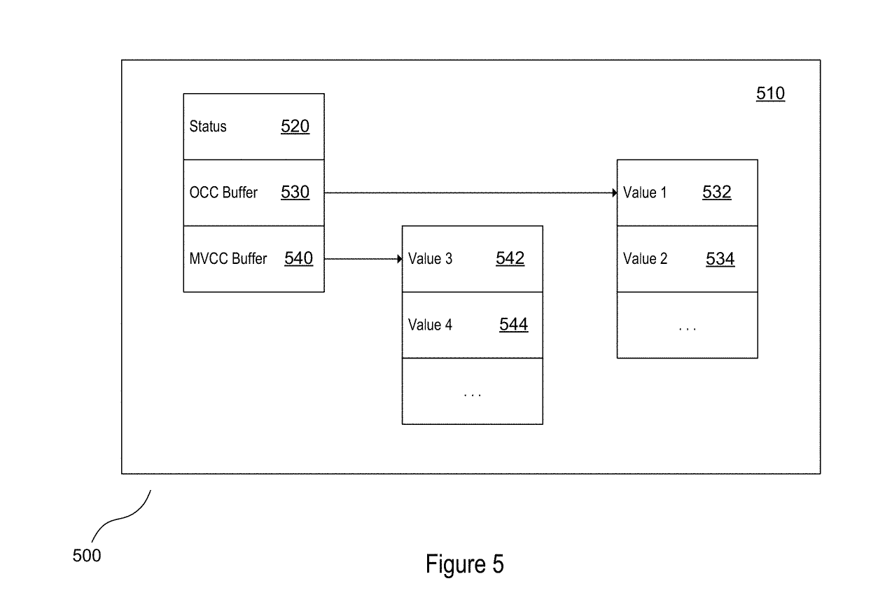

An update of a transaction may be written to an optimistic concurrency control (OCC) buffer in a transaction record when in an OCC mode, and an update of a transaction may be written to a multi-version concurrency control (MVCC) buffer in a transaction record when in an MVCC mode. FIG. 5 is a block diagram 500 illustrating an example transaction record 510. The transaction record may have a status field to indicate the status of the transaction, such as whether the transaction was committed or aborted. In an example, the transaction status field 520 indicates that the transaction was committed by indicating the commit time of the transaction.

OCC buffer 530 may be included in transaction record 510 as well as MVCC buffer 540. A write request of a transaction may write to OCC buffer 530 or to MVCC buffer 540. Illustrated in FIG. 5 is a first value 532 and a second value 534 written to OCC buffer 530. While two values are illustrated within OCC buffer 530, OCC buffer 530 may include any number of fields for any number of data values written to OCC buffer 530. Similarly, a third value 542 and a fourth value 544 are written to MVCC buffer 540. While two values are illustrated within MVCC buffer 540, MVCC buffer 540 may include any number of fields for any number of data values written to MVCC buffer 540.

In an example, the concurrency control mode of a data slot may determine whether an update is written to OCC buffer 530 or to MVCC buffer 540. For example, when a data slot is in OCC mode, an update to that slot may be written to OCC buffer 530. Conversely, when a data slot is in MVCC mode, an update to that slot may be written to MVCC buffer 540. Accordingly, MVCC buffer 540 may contain updates for data slots under MVCC mode, and OCC buffer 530 may contain updates for data slots under OCC mode.

In an example, the transaction record may be stored within non-volatile memory. In an example, the transaction record is stored in a transaction record buffer, which may be stored in a per-thread ring buffer, such as collection of per-thread ring buffers 230 of FIG. 2. In an example, OCC buffer 530 is reclaimed, i.e. garbage collected, upon a commit of the associated transaction. In an example, OCC buffer 530 is reclaimed where the values within OCC buffer 530 are committed to their respective data slots, e.g. in place data value 142 of FIG. 1.

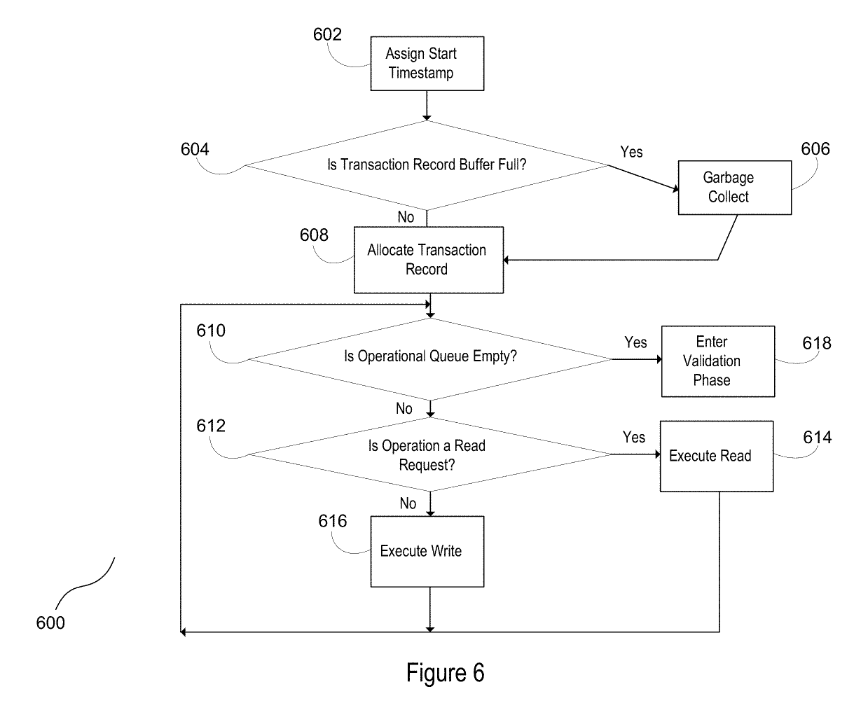

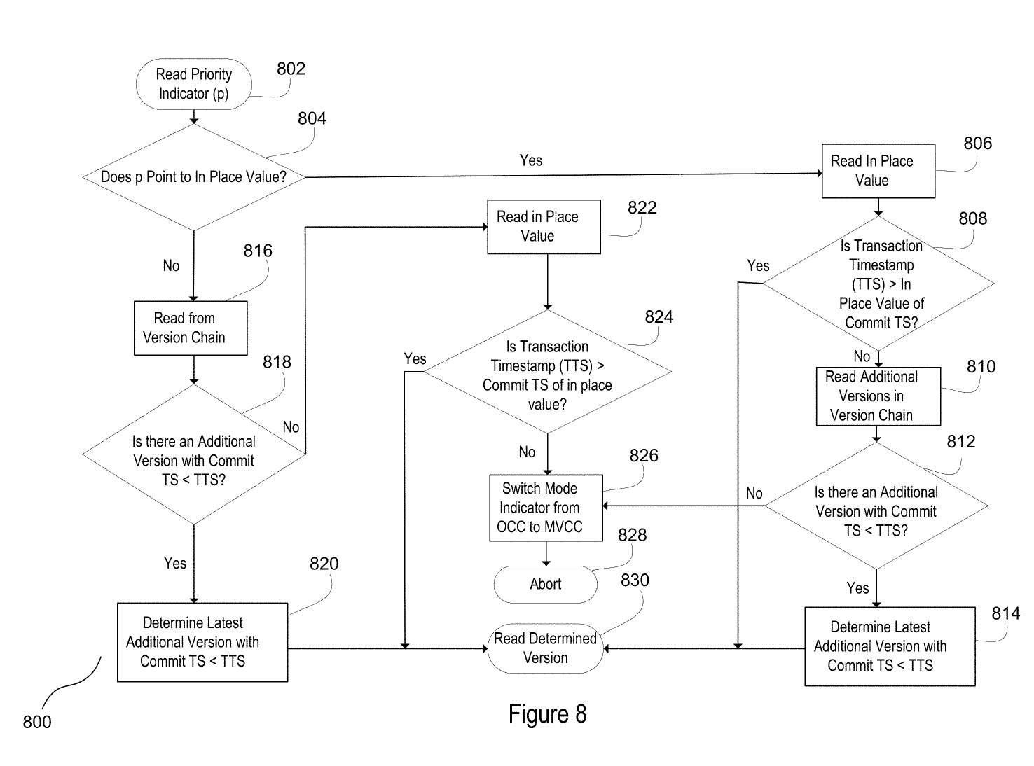

To maintain the atomicity of a transaction and ensure serializability is maintained, a transaction may be both executed and validated prior to committing. FIG. 6 is an example flowchart illustrating a method 600 for executing a transaction. At block 602, a start timestamp is assigned to a transaction entering the execution phase. At block 604 it is determined whether a transaction record buffer storing any number of transaction records is full. If the transaction record buffer is full such that there is not room to store a transaction record of the transaction, the transaction record buffer may be garbage collected at block 606 to create sufficient space to store the incoming transaction record.

Where the transaction record buffer is not full, or after a full or partial garbage collection at block 606, space within the transaction record buffer may be allocated to the transaction at block 608. In an example, operations in the transaction entering the execution phase may be ordered in a queue, and the transactions may be executed by order of transaction within the queue. At block 610 it may be determined whether the operational queue is empty. A negative determination may lead to any reads or writes of the transaction being executed in program order. Specifically, it may be determined whether an operation is a read request at block 612. If the operation is determined to be a read request, the read is executed at block 614, e.g., using the method of FIG. 8 with the start timestamp (assigned at block 602) as the transaction timestamp (TTS), followed by a return to block 610. If the operation is determined to not be a read request, e.g. where the operation is a write request, the write is executed at block 616, followed by a return to block 610. This process may be repeated until any read and/or write requests in the operational queue are executed. Where it is determined at block 610 that the operational queue is empty, the validation phase as described below, e.g. at block 618, may be performed.

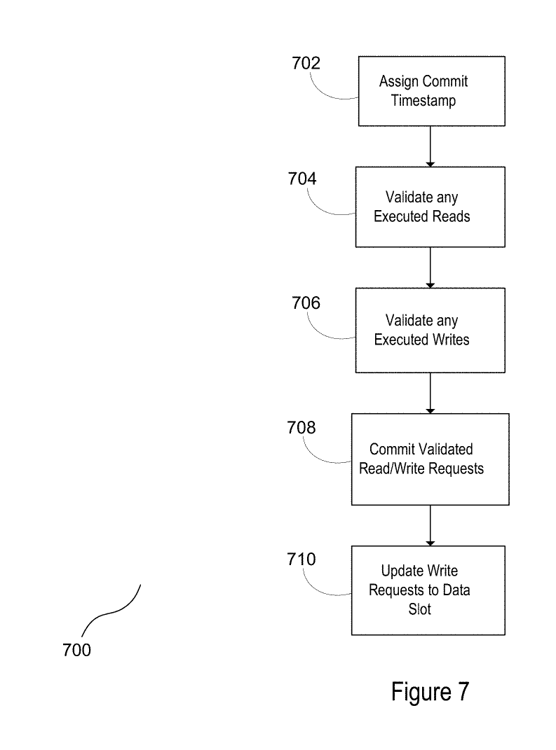

Before a transaction is committed, it is validated to ensure that any executed operations resulting from the executed transaction are valid and serializability will not be violated if the transaction commits. FIG. 7 is an example flowchart illustrating a method 700 for validating a transaction. When an executed transaction enters the validation phase, it receives a commit timestamp as illustrated at block 702. In an example, where the transaction is successfully validated, the received commit timestamp is updated to a status field of the transaction record as will be described at block 708 below, such as status field 520 of FIG. 5. Otherwise, where the transaction is not successfully validated, the transaction is aborted and the status field is modified to indicate that the transaction was aborted.

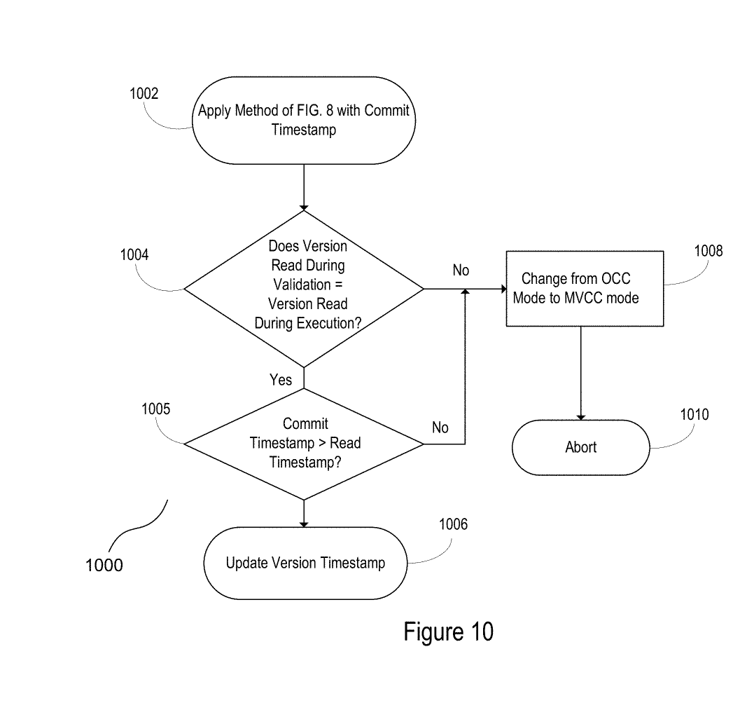

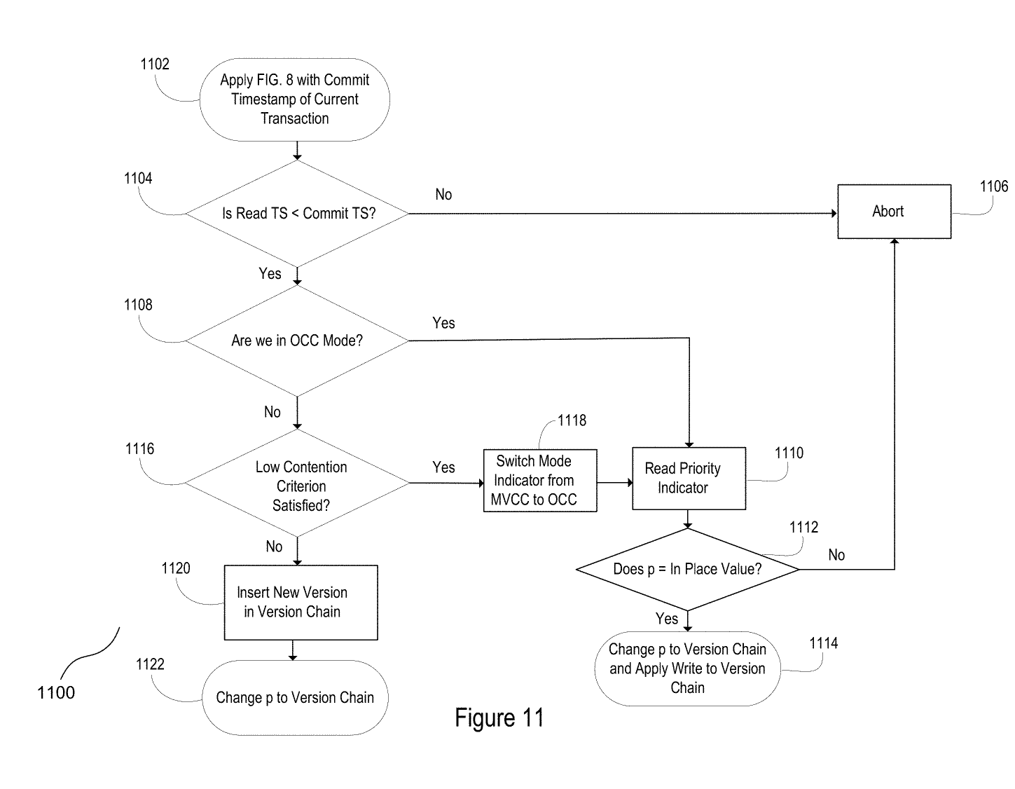

Each executed read may be validated at step 704, as will be further described in FIG. 10. Additionally, each executed write may be validated at step 706, as will be described in FIG. 11. The validated read requests and the validated write requests are committed at block 708. Upon committing, the status field of the transaction record may be updated to the commit timestamp assigned at block 702. In an example, the transaction commit occurs atomically upon changing the status field of the transaction record.

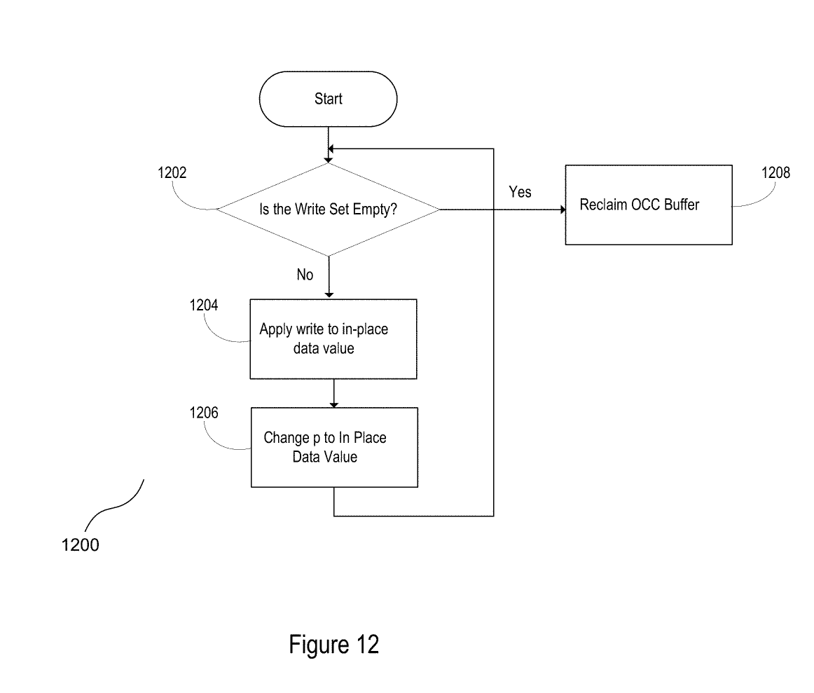

At block 710, the committed write requests may be installed sequentially to their respective data slots. In an example, installing the write requests to their respective data slots may occur during a post-commit phase, which is described below in FIG. 12. In an example, updates of both the OCC buffer and the MVCC buffer are installed to the in-place data value.

A transaction may take the form of a read request or a write request and a read request and/or a write request may be executed and validated. FIG. 8 is a flowchart illustrating a method 800 for executing a read request, e.g. a read request executed at block 610 of FIG. 6. At block 802 a priority indicator (p) of the data slot is read, e.g. priority indicator 246 of FIG. 2. It is determined at block 804 whether the priority indicator (p) points to the in-place data value of the data slot, or a version chain of the data slot, e.g. version chain locator 248 of FIG. 2.

A determination that priority indicator (p) points to the in-place data value leads to block 806, where the in-place data value is read. In an example, an assigned commit timestamp of the in-place data value may also be read and it may be determined at block 808 whether a transaction timestamp is greater than the commit timestamp of the in-place data value. In an example, the transaction timestamp may be a start timestamp of the transaction, such as the start timestamp assigned at block 602 in FIG. 6. In an example, the transaction timestamp may be the time at which the transaction was committed. This transaction timestamp may be compared to the commit timestamp of the in-place data value to determine whether a different transaction committed to the in-place data value field subsequent to start of the transaction execution.

Where the transaction timestamp is determined to be greater than the commit timestamp of the in-place data value, the in-place data value may be read as illustrated at block 830. Where the transaction timestamp is not determined to be greater than the commit timestamp of the in-place data value, a read may occur from the version chain at block 810. Specifically, it may be determined at block 812 whether there are any additional committed versions within the version chain that have a commit timestamp that is less than the transaction timestamp. Where there are additional committed versions that have a commit timestamp less than the transaction timestamp, the additional version having the greatest timestamp that is less than the transaction timestamp may be determined at block 814. The determined version may be read at block 830.

It may be determined that there are no committed versions that have a commit timestamp less than the transaction timestamp. This may be because any committed version that had a commit timestamp less than the transaction timestamp may have been overwritten or garbage collected. Where it is determined that there are no additional committed versions within the version chain that have a commit timestamp less than the transaction timestamp, the mode indicator, e.g. in mode indicator field 144 of FIG. 1, is switched from optimistic concurrency control (OCC) to multi-version concurrency control (MVCC) at block 826. In an example, the version chain may be initialized prior to switching concurrency modes such that the difference between an older empty MVCC chain and a concurrency mode that was newly switched to MVCC mode may be ascertained. A determination that the MVCC mode has not been newly switched from OCC mode may indicate that there is low contention for the data slot such that the concurrency control mode may be switched from MVCC mode to OCC mode. The executing transaction may then be aborted at block 828.

Looking back to block 804, it may be determined that the priority indicator (p) does not point to the in-place data value. In an example, p may point to the version chain and not the in-place data value. A read occurs from the version chain at block 816 where it is determined that p points to the version chain. Similar to block 812, it may then be determined at block 818 whether there are any additional versions having a commit timestamp that is less than the transaction timestamp. Similar to block 814, where there are additional committed versions that have a commit timestamp less than the transaction timestamp, the additional committed version having the greatest timestamp that is less than the transaction timestamp may be determined at block 820. The determined version may be read at block 830.

Where it is determined that there are no additional versions having a commit timestamp that is less than the timestamp of the executing transaction, the in-place data value may be read at block 822. Similar to block 808, it may be determined at block 824 whether the transaction timestamp is greater than the commit timestamp of the in-place data value. Where it is determined that the transaction timestamp is greater than the in-place data value of the commit timestamp, the in-place data value may be read at block 830.

Where it is determined that the transaction timestamp is not greater than the commit timestamp of the in-place data value, the mode indicator, e.g. in mode indicator field 144 of FIG. 1, may be switched from optimistic concurrency control (OCC) to multi-version concurrency control (MVCC) at block 826. As described above, the version chain may be initialized prior to switching concurrency modes. The executing transaction may then be aborted at block 828.

As described at FIG. 5, a transaction record of a transaction may include an optimistic concurrency control (OCC) buffer and a multi-version concurrency control (MVCC) buffer. When executing a write request, the updated value may be written to the OCC buffer where the data slot associated with the write request is in OCC mode, and the updated value may be written to the MVCC buffer where the data slot associated with the write request is in MVCC mode.

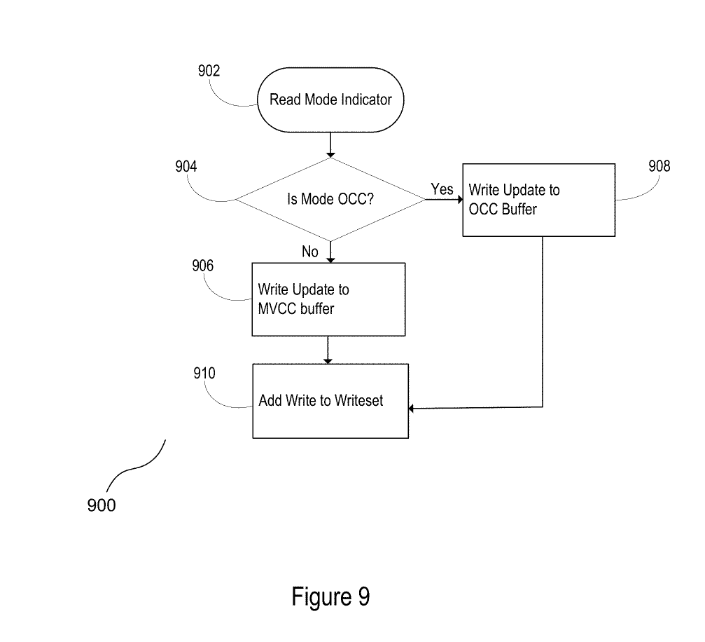

FIG. 9 is a flowchart illustrating a method 900 for executing a write request, e.g. a write request executed at block 610 of FIG. 6. At block 902, a mode indicator of a data slot, e.g. in mode indicator field 144 of FIG. 1, is read. It is determined at block 904 whether the mode indicator indicates that the data slot is in OCC mode or MVCC mode. Where it is determined that the data slot is in OCC mode, the OCC buffer may be updated with the written value as indicated at block 908, and the write operation may be added to a write set, i.e., a set of write operations that are performed by a transaction, to be validated at block 910. Where it is determined that the data slot is in MVCC mode, the MVCC buffer may be updated with the written value as indicated at block 906, and the write operation may be added to a write set to be validated at block 910. Accordingly, the updated value may be written to the OCC buffer or the MVCC buffer depending on whether the mode indicator indicates that the data slot is in the OCC mode or the MVCC mode respectively.

An operation may be executed and then added to a read set, i.e., a set of read operations that are performed by a transaction, and/or write set for validation. In an example, a read operation may be validated in the order in which it was added to the read set. Similarly, a write operation may be validated in the order in which it was added to the write set. FIG. 10 is a flowchart illustrating an example method 1000 for validating a read operation, e.g. a read operation validated at block 704 of FIG. 7. In an example, the commit timestamp, such as the timestamp assigned during the validation phase as described at block 702 of FIG. 7, of a transaction is updated prior to validation. At block 1002, the method of FIG. 8 may be applied with the commit timestamp as the transaction timestamp (TTS). It may then be determined at block 1004 whether the version read during the execution phase, i.e. at block 830 of FIG. 8, is the same as the determined version read during the validation phase at block 1002. Where it is determined that the versions are the same, it may be determined that the commit timestamp is greater than the timestamp of the read version at block 1005. Where a positive determination is made at block 1004 and at block 1005, the timestamp of the read version is updated at block 1006. In an example, the timestamp of the read version may be updated to the commit timestamp assigned at block 702 of FIG. 7. In an example, the timestamp of the read version may be updated to the time at which the validation phase for the transaction began.

Where it is determined at block 1004 that the version read during the execution phase is not the same as the version read during the validation phase, or where it is determined at block 1005 that the commit timestamp is not greater than the timestamp of the read version, the concurrency mode of the data slot may be changed from optimistic concurrency control (OCC) mode to multi-version concurrency control (MVCC) mode at block 1008. In an example, the version read during the execution phase may not be the same as the version read during the validation phase because of a read-write conflict, that is, because a concurrent transaction may have modified the version read during the execution phase prior to validation. The transaction may be aborted at block 1010 following the concurrency mode change at block 1008. Accordingly, the transaction may be validated, or the concurrency mode of the data slot may be updated provided the transaction is not validated.

FIG. 11 is an example method 1100 for validating a write operation, e.g. a write operation validated at block 706. At block 1102, the method of FIG. 8 may be applied with the commit timestamp as the transaction timestamp (TTS). It may then be determined at block 1104 whether the read commit timestamp of the determined version read at block 1102 is less than the commit timestamp of the current transaction. In an example, the commit timestamp of the current transaction being less than the read timestamp of the determined version read may indicate that a concurrent transaction with a later commit timestamp may have read the determined version subsequent to the execution of this transaction. A commit of the transaction in this scenario may violate serializability. Thus, where it is determined that the commit timestamp of the current transaction is less than the read timestamp of the determined version read, the transaction may be aborted at block 1106.

A positive determination at block 1104 however, leads to the determination at block 1108 as to whether the data slot associated with the write transaction is in optimistic concurrency control (OCC) mode or multi-version concurrency control (MVCC) mode. The mode of the data slot may be indicated by the mode indicator of the data slot, e.g. in mode indicator field 144 in FIG. 1. Where it is determined that the data slot is in OCC mode, the priority indicator of the data slot is read at block 1110, e.g. priority indicator 246 of FIG. 2, and it is determined at block 1112 whether the priority indicator points to the in-place data value of the data slot, e.g. 142 of FIG. 1, or to the version chain of the data slot e.g. version chain locator 248 of FIG. 2. In an example, the priority indicator indicates whether a read should first occur from the committed in-place data value of the data slot or the version chain of the data slot.

A determination that the priority indicator points to the version chain may indicate an erroneous state in the protocol as described in greater detail below, and the transaction may abort at block 1106. Where it is determined that the priority indicator does not point to the version chain, but rather the in-place data value of the data slot, the priority indicator is changed from pointing to the in-place data value to the version chain and the write may be applied to the version chain at block 1114.

Returning to block 1108, it may be determined that the concurrency mode is not in optimistic concurrency control (OCC) mode. For example, it may be determined by the mode indicator of the data slot that the data slot is in multi-version concurrency control (MVCC) mode. Where it is determined at block 1108 that the data slot is not in OCC mode, it is determined at block 1116 whether a low contention criterion is satisfied. In an example, the low contention criterion may be satisfied where the version chain of the data slot is empty. In an example, the low contention criterion may be satisfied where no additional versions of the data slot have been created, or where no additional version of the data slot is currently stored within a transaction record buffer. In an example, the low contention criterion is satisfied where a version chain locator of the data slot, e.g. version chain locator 248 of FIG. 2, does not point to any additional versions, i.e. versions of the data value of the data slot other than the data value stored within the in-place data value field. In an additional example, the low contention criterion may be satisfied where the version chain stored within the transaction record buffer is made up of additional versions less than a threshold.

A determination that the low contention criteria is satisfied may indicate a period of low contention regarding transactions associated with the data slot. Where the low contention criterion is determined to be satisfied at block 1116, the concurrency mode of the data slot may be switched from MVCC mode to OCC mode at block 1118, followed by a priority indicator read at block 1110, a determination as to whether the priority indicator points to the in-place data value at block 1112, and, depending on the determination, an update to the version chain at block 1114 or an abort of the transaction at block 1106.

Specifically, a determination at block 1112 that the priority indicator does not point to the in-place data value may lead to an abort at block 1106. If prior transactions have successfully committed and the updates and/or writes of the transaction have been installed, then in a period of low contention, a successful transition to OCC mode may be indicated where the priority indictor points to the in-place data value. The priority indicator not pointing to the in-place data value may indicate that the last committed transaction to modify the data slot did not successfully complete installation. In MVCC mode, the latest committed update may be located within the value chain. In OCC mode however, the latest committed value is expected to be in the in-place value. Thus, in an example, the transaction may abort at block 1106. In another example, a determination at block 1112 that the priority indicator does not point to the in-place data value may be followed by switching the concurrency mode from OCC mode to MVCC mode.

In an example, a determination that the low contention criterion is not satisfied may indicate that the version chain is not empty, that the version chain makes up greater than a threshold amount of additional versions, etc. Where the low contention criterion is not satisfied, a new version may be created in the version chain at block 1120. In an example, versions within the version chain are ordered by commit time, and the newly created version may be placed within the version chain according to the commit time of the newly created version. The priority indicator may then be changed to point to the version chain at block 1122.

Once a transaction is committed, post-commit operations may be executed. FIG. 12 is a flowchart illustrating a method 1200 for executing post-commit operations. Subsequent to the commit of a transaction for instance, writes of the transaction write set may be updated to their respective in-place data values. Writes from the write set may be installed either from an OCC buffer of the transaction record or from an additional version in the version chain. At block 1202, it may be determined whether a write set of the transaction is empty. If the write set is not empty, at block 1202, a write within the write set may be applied to its respective in-place data value of its respective data slot at block 1204. At block 1206, the priority indicator may be changed to point to the in-place data value of the data slot upon updating the in-place data value. In an example, the priority indicator pointing to the in-place data value field indicates that a read should first occur from the committed in-place data value field of the data slot. Thus, upon updating the in-place data value field, the priority of a read may be changed from the version chain field to the in-place data value field. Changing the priority indicator to the in-place data value may be followed by a return to block 1202.

Once the write set of the transaction has been installed, the OCC transaction buffer, i.e., the memory holding data stored when in an optimistic concurrency control (OCC) mode, may be reclaimed. Where the write set is determined to be empty, the OCC buffer is reclaimed at block 1208. In an example, an identification value may be stored within the OCC buffer upon reclamation to indicate the completion of the post-commit phase.

In an example, a transaction may commit and the post-commit phase may fail to partially or fully execute. This may occur, for example, where a thread crashes during the post-commit phase. Where the post-commit phase fails to perform, a modified post-commit phase may be performed. During the modified post-commit phase, it may be determined whether a version within the version chain has a latest commit time, and if so, the in-place data value of the determined version is updated. Subsequent to the update, the priority indicator may also be updated to point to the in-place data value.

To promote space and computational efficiency, garbage collection may occur within a transaction record such that memory within a transaction record is reclaimed. Garbage collection may occur in the foreground, such that garbage collection is performed by transaction processing threads that have run out of space in their ring buffer, or in the background, such that garbage collection is performed by dedicated garbage collection threads. In an example, the OCC buffer and/or MVCC buffer may be reclaimed periodically, such that an OCC buffer and/or an MVCC buffer may be reclaimed after a specified period of time. In an example, periodic garbage collection occurs in the background, such that garbage collection is performed by garbage collection threads distinct from the transaction processing threads that are dedicated to reclaiming memory. This temporal garbage collection method may be performed at per-thread ring buffers, e.g. first thread ring buffer 232 or second thread ring buffer 234 of FIG. 2. In an example, the per-thread ring buffers may be garbage collection threads dedicated to reclaiming memory within the collection of per-thread ring buffers, e.g. collection of per-thread ring buffers 230 of FIG. 2. To reclaim memory within an inactive thread, the location of each ring buffer may be stored for reference, e.g. within non-volatile memory.

In an example, a transaction processing thread may reclaim space within its per-thread ring buffer where the ring buffer lacks sufficient available space for the transaction processing thread to allocate a new transaction record. In an example, transaction records from the per-thread ring buffer for a transaction processing thread that lacks sufficient space are garbage collected in the foreground. A transaction record may also be reclaimed where the status field of a transaction record, e.g. status field 520 of FIG. 5, indicates that the transaction was aborted. In an example, a buffer of a transaction record may also be reclaimed where the status field indicates that the transaction was committed, i.e. if a commit timestamp value is stored within the status field, where any updates were installed to OCC mode data slots, and where the OCC buffer indicates the completion of the post-commit phase, i.e. by an identification value.

The features disclosed in this specification (including any accompanying claims, abstract and drawings), and/or the elements of any method or process so disclosed, may be combined in any combination, except combinations where at least some of such features and/or elements are mutually exclusive.

In the foregoing description, numerous details are set forth to provide an understanding of the subject disclosed herein. However, various examples may be practiced without some of these details. Some examples may include modifications and variations from the details discussed above. It is intended that the appended claims cover such modifications and variations.

What is claimed is:

1. A method comprising:
controlling a concurrency control mode of a data slot that stores a data value, wherein the concurrency control mode determines how a transaction is handled responsive to a read-write conflict, and controlling the concurrency control mode comprises:
responsive to detecting a read-write conflict for the data slot, changing the concurrency control mode from an optimistic concurrency control mode to a multi-version concurrency control mode; and
changing the concurrency control mode from the multi-version concurrency control mode to the optimistic concurrency control mode responsive to detecting that the data slot satisfies a low contention criterion.

2. The method of claim 1, where the read-write conflict for the data slot is detected by:
comparing a first version of the data value read at a first time with a second version of the data value read at a second time different than the first time; and
determining that the first version and the second version are different.

3. The method of claim 2, wherein the data value read at the first time is read during an execution phase of the transaction and the data value read at the second time is read during a validation phase of the transaction.

4. The method of claim 1, wherein the read-write conflict for the data slot is detected by:
assigning a transaction timestamp to the transaction; and
determining that the transaction timestamp is earlier in time than a commit time of the stored data value.

5. The method of claim 4, wherein, when in the optimistic concurrency control mode, the transaction is aborted responsive to detecting that the transaction timestamp is earlier in time than a commit time of the stored data value.

6. The method of claim 1, wherein an additional version of the stored data value is stored within a transaction record and is assigned a commit time.

7. The method of claim 6, wherein any additional version of the stored data value stored within a transaction record is located by a version chain locator in the data slot.

8. The method of claim 7, wherein the transaction record is in a per-thread ring buffer and the additional version of the stored data value is ordered by commit time in a version chain located by the version chain locator.

9. The method of claim 8, wherein the low contention criterion is satisfied where the version chain locator in the data slot does not locate any created additional version of the stored data value.

10. The method of claim 1, wherein, when in the optimistic concurrency control mode, a write of the transaction is updated to an optimistic concurrency buffer in a transaction record of the transaction, and wherein the transaction record comprises the optimistic concurrency control buffer and a multi-version concurrency control buffer.

11. The method of claim 10, wherein the transaction record further comprises a transaction status field to indicate a transaction status of the transaction.

12. The method of claim 10, wherein the optimistic concurrency control buffer is stored within a per-thread ring buffer, and wherein the optimistic concurrency control buffer is reclaimed upon a commit of the transaction.

13. The method of claim 1, wherein, when in the multi-version concurrency control mode, a write of the transaction is updated to a multi-version concurrency control buffer in a transaction record of the transaction.

14. A system comprising:
a processor; and
a set of memory resources storing:
a data slot comprising:
a committed in-place data value; and
a mode indicator to indicate whether a concurrency control mode of the data slot is in an optimistic concurrency control mode that aborts a transaction upon detecting a read-write conflict, or a multi-version concurrency control mode that creates an additional version of the committed data value responsive to detecting the read-write conflict; and
instructions in memory to be executed by a processor, the instructions when executed to:
change the concurrency control mode from the optimistic concurrency control mode to the multi-version concurrency control mode responsive to detecting the read-write conflict for the data slot; and
change the concurrency control mode from the multi-version concurrency control mode to the optimistic concurrency control mode responsive to detecting that the data slot satisfies a low contention criterion.

15. The system of claim 14, wherein the data slot further comprises a version chain locator to locate any created additional version of the committed data value.

16. The system of claim 15, wherein the data slot further comprises a priority indicator to indicate whether a read should first occur from the committed in-place data value of the data slot or the version chain locator of the data slot.

17. The system of claim 15, wherein the low contention criterion is satisfied where the version chain locator of the data slot does not locate any created additional version of the committed data value.

18. The system of claim 15, wherein the instructions in memory further comprise instructions to assign a commit timestamp to an additional version of the committed data value upon validation of the additional version, and wherein the validated additional version is ordered by commit time.

19. A non-transitory computer-readable medium comprising instructions executable by a processor to:
detect a read-write conflict for a data slot;
responsive to detecting the read-write conflict, change a concurrency control mode of the data slot from an optimistic concurrency control mode that aborts a transaction upon detecting a read-write conflict, to a multi-version concurrency control mode that creates an additional version of the stored data value;
detect that a version chain locator of the data slot does not point to any additional version of the stored data value;
responsive to detecting that the version chain locator does not point to any additional version of the stored data value, change the concurrency control mode from the multi-version concurrency control mode to the optimistic concurrency control mode.

20. The non-transitory computer-readable medium of claim 19, wherein the read-write conflict is detected by:
assigning a transaction timestamp to a received transaction; and
determining that the transaction timestamp is earlier in time than a commit time of a stored data value in the data slot.
